(19) United States
(12) Patent Application Publication
(10) Pub. No.: US 2002/0147009 A1
(43) Pub. Date: Oct. 10, 2002

(54) Wireless telephone system with both cordless short range communication and long range mobile wireless cellular telephone communication

(75) Inventor: Rolf Kocheisen, Austin, TX (US)

Correspondence Address: Volel Emile, International Business Machines Corporation, Intellectual Property Law Department, Internal Zip 4054, 11400 Burnet Road, Austin, TX, 78758, US

(73) Assignee: International Business Machines Corporation, Armonk, NY

(21) Appl. No.: 09/826,707

(22) Filed: Apr. 5, 2001

(51) Int. Cl. H04Q 7/20

(52) U.S. Cl. 455/426; 455/421; 455/406

(57) ABSTRACT

Cordless and wireless telephone communication functions are combined in a unitary wireless telephone system that comprises a mobile wireless telephone member combining short range radio frequency communication implementation for transmitting and receiving voice data over a short range, with long range radio frequency communication implementation for transmitting and receiving voice data over a long range. The system also includes stationary communication means for receiving and transmitting voice data from and to the mobile wireless member voice data over said short range and stationary communication means for respectively receiving and transmitting voice data from and to the mobile wireless member voice data over said long range.

The system may also include an implementation for determining whether said mobile wireless telephone member is outside said short range when said member is receiving or transmitting said voice data, together with an implementation for communicating with said mobile wireless telephone member through said stationary short range radio frequency whenever said member is determined not to be outside of the short range and an implementation for communicating with said mobile wireless telephone member through the stationary long range radio frequency implementation whenever said member is determined to be outside of said short range.

### TECHNICAL FIELD

The present invention relates to telecommunications systems and particularly to mobile wireless telephone systems.

### BACKGROUND OF RELATED ART

With the globalization of business, industry and trade wherein transactions and activities within these fields have been changing from localized organizations to diverse transactions over the face of the world, the telecommunications industries have, accordingly, been expanding rapidly. While telecommunications technology development has been advancing to keep pace with expanded demands, communication channel bandwidth remains the commodity still in short supply. Bandwidth is the amount of data that can be transmitted via a given communications channel in a given unit of time (generally one second). Channel and bandwidth shortages still remain the factors that limit the efficiency of wireless long range mobile telecommunications and maintain the cost of such wireless communications at a premium. One way that such long range wireless communication costs may be reduced would be to maximize the use of alternative telecommunications, such as the conventional wired telephone systems and, particularly, short range wireless or “cordless” telecommunications.

In order to understand this challenge, the three principal forms of telecommunication should be briefly considered. The standard wired telecommunications system, which has been in use worldwide for well over 100 years, is the conventional handheld or speaker input wired into a base which in turn is wired into a Public Switched Telephone Network (PSTN) with wired switched channel paths to and from other telephones or like devices through their bases. These telephones are respectively connected to the PSTN via local switching centers or switching nodes in a fully wired telecommunication system. Conventionally these switching centers have many telephones connected to each. The centers operate to control the channel connections, i.e. switch into and out of the PSTN, those calls originated or terminated at telephone stations.

In addition, there have been developed over the past 20 years, two major mobile wireless systems: 1) the short range wireless radio frequency (RF) “cordless” telephone system; and 2) the mobile wireless long range RF “wireless” telephone system, which has been commercialized primarily as the “cellular” telephone system.

The cordless telephone is basically a combination telephone and RF receiver/transmitter. The cordless phone has a base and a handset. The base is wired through any standard phone jack into the conventional PSTN. The base receives the incoming call as a normal phone line signal, converts the signal into an FM RF signal (preferably digital in present technology) and broadcasts the signal over a short range to the mobile handset which receives the signal and converts it into the analog signal that is heard over the phone. When the user speaks, the handset converts the analog speech signal into an FM RF digital signal which is broadcast back to the base which in turn receives and converts the signal back into the line signal to the PSTN. Thus, the cordless telephone base looks like and operates like a conventional wired phone base as far as the PSTN is concerned.

The cordless handset and its base operate on a frequency pair that allows the user to speak and listen at the same time. Cordless telephones originally broadcast analog signals. However, such analog communication had significant privacy and security problems. Thus, in the mid-1990's, cordless phone systems were granted a wide range of frequencies: 900-928 MHz by the FCC which enabled such phones to broadcast digitally; for example, by Digital Spread Spectrum (DSS).

We will now discuss the wireless, e.g. cellular long range RF system. The one thing that the cellular long range communication system has in common with the short range cordless system is that both eventually have a base which looks and acts like a standard wired telephone base with respect to the PSTN.

Before the cellular wireless phone system was developed, long range mobile wireless phones were relatively rudimentary; they were usually in automobiles. There was usually one central tower with about 25 channels available on the tower. The mobile wireless telephone needed a large powerful transmitter, usually in the automobile, which had to transmit up to 50 miles, which was too cumbersome for any personal or portable phone.

In the cellular system for the handheld mobile wireless phone, an area such as a city is broken up into small area cells. Each cell is about 10 square miles in area. Each has its base station that has a tower for receiving/transmitting and a base connected into PSTN. Even though a typical carrier is allotted about 800 frequency channels, the creation of the cells permit extensive frequency reuse so that tens of thousands of people in the city can be using their cell phones simultaneously. Cell phone systems are now preferably digital with each cell having over 160 available channels for assignment to users. In a large city there may be hundreds of cells, each with its tower and base station. Because of the number of towers and users per carrier, each carrier has a Mobile Telephone Switching Office (MTSO) which controls all of the base stations in the city or region and controls all of the connections to the land based PSTN. When a client cell phone gets an incoming call, MTSO tries to locate what cell the client mobile phone is in. The MTSO then assigns a frequency pair for the call to the cell phone. The MTSO then communicates with the client over a control channel to tell the client or user what frequency channels to use. Once the user phone and its respective cell tower are connected, the call is on between the cell phone and tower via two way long range RF communication. In the United States, cell phones are assigned frequencies in the 824-894 MHz ranges. Since transmissions between the cell telephone and cell tower are digital but the speaker and microphone in the telephone are analog, the cell telephone has to have a D to A converter from the input to the phone speaker, and an A to D converter from the microphone to the output to the cell tower.

Although the cellular telephone and cordless telephone systems are both connected into the land based PSTN respectively through their cordless base station and tower base station, they have coexisted quite independent of each other over the years of their commercial development. This has led to inefficiencies, e.g. cellular phone use in areas where short range cordless telephone use was or could have been made available. It would be desirable to maximize the use of cordless telephone functions in short range distances where both cordless and cellular functions could be used without sacrificing any of the functions of cellular telephones for long range wireless communication.

### SUMMARY OF THE PRESENT INVENTION

The present invention optimizes the usage of such cordless and wireless communication functions by combining them in an unitary wireless telephone system which broadly comprises a mobile wireless telephone member that combines short range radio frequency communication means for transmitting and receiving voice data over a short range with long range radio frequency communication means for transmitting and receiving voice data over a long range. The system also includes stationary communication means for receiving and transmitting voice data from and to said mobile wireless member voice data over said short range and stationary communication means for respectively receiving and transmitting voice data from and to said mobile wireless member voice data over said long range.

The system may also include means for determining whether said mobile wireless telephone member is outside said short range when said member is receiving or transmitting said voice data, together with means for communicating with said mobile wireless telephone member through said stationary short range radio frequency means whenever said member is determined not to be outside of said short range and means for communicating with said mobile wireless telephone member through said stationary long range radio frequency means whenever said member is determined to be outside of said short range.

The telephone system preferably has a cordless base member, wired into a wired telephone network, for receiving and transmitting from and to said mobile wireless member voice data over said short range whereby the mobile wireless telephone member communicates through this cordless base member whenever said member is determined not to be outside of said short range.

The stationary communication means for respectively receiving and transmitting to and from said mobile wireless member voice data over said long range preferably includes a wireless telephone area base station wired into said wired telephone network. Also, for best results, the wireless telephone system is a cellular phone system and said telephone base station area is in an area cell within said cellular system.

The system of this invention is capable of supporting means in said mobile wireless member enabling a telephone user to switch between said short range and long range communication means whenever said member is not outside of said short range.

In accordance with another aspect of the present invention, means are provided in said wired telephone network for tracking the respective times of telephone communications through said short range and said long range means for billing purposes.

The present invention also covers the mobile wireless telephone member itself which comprises wireless means for communicating with a cordless telephone station within a short distance range in combination with means for communicating with a station in a cell of a cellular telephone system over a longer distance outside of said short distance range.

### BRIEF DESCRIPTION OF THE DRAWINGS

The present invention will be better understood and its numerous objects and advantages will become more apparent to those skilled in the art by reference to the following drawings, in conjunction with the accompanying specification, in which:

FIG. 1 is a generalized diagrammatic view of a portion of a Public Switched Transmission Network showing channel paths to and from both conventional and mobile wireless channels on which the present invention is implemented;

FIG. 2 is a generalized diagrammatic view of a mobile wireless telephone member according to the present invention partially broken away to show the elements of the member;

FIG. 3 is a flowchart describing how the telephone system of the present invention handles an incoming telephone call to the mobile wireless telephone member; and

FIG. 4 is a flowchart describing how the telephone system of the present invention handles an outgoing telephone call from the mobile wireless telephone member.

### DETAILED DESCRIPTION OF THE PREFERRED EMBODIMENT

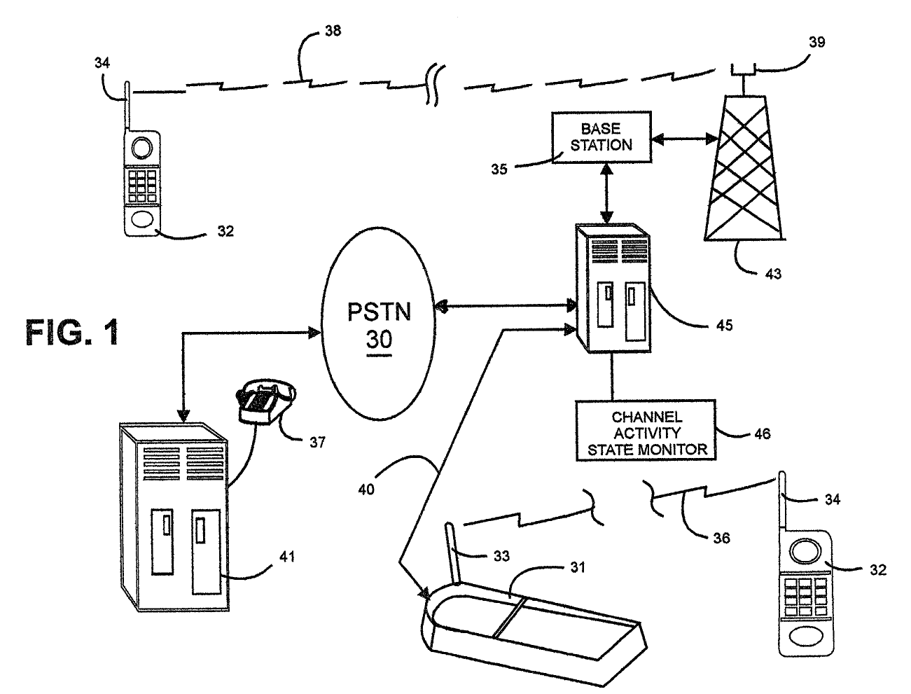

Referring to FIG. 1, there is shown a generalized diagrammatic view of a portion of a PSTN showing channel paths to and from both conventional wired and mobile wireless channels and devices. Conventional telephones, e.g. phone 37, are connected to the PSTN 30 via local switching centers or switching nodes 41 and 45 in a fully wired telecommunications system. Conventionally, these switching nodes 41 and 45 have many telephones 37 connected to each. The centers operate to control the channel connections, i.e. switch into and out of the PSTN 30 those calls originated or terminated at telephone stations 37. In a similar way, mobile or cellular telephones 32 are connected into the PSTN 30. When the mobile wireless telephone member 32 is operating in the short range mode, digital signals 36 are transmitted and received to and from cordless telephone base 31 via telephone antenna 34 through telephone base 33. This happens if the telephone member 32 is, as here, within the short range RF digital broadcast scope of cordless base 31. The short range RF scope of broadcast to and from cordless base 31 is in the order of a few hundred feet. Where the mobile wireless telephone 32 moves to a location more remote from cordless base 31, i.e. outside of short RF range, then there is long range cellular telephone communication path 38 from cellular phone antenna 34 to antenna 39 on tower 43. In both the long range cellular RF communication by telephone 32 and in the short range RF communication to the cordless base, the distribution or routing of the telephone call to, from and within the PSTN 30 is quite similar to the routing of conventional wired telephone calls. In the short range wireless communication, through cordless base 31, the signals are routed via line 40 to switching center 45 which then controls the routing of the call to PSTN 30. Similarly, in the long range RF communication via tower 43, the signals are passed through base station 35 to switching center 45 which then controls the routing of the call to PSTN 30. The various switching centers 45 within the PSTN may be monitored by channel activity state monitors 46 to track activity for billing and other purposes. This is a cellular telephone system. Therefore, tower 43 and base 35 make up an area cell station.

It should be noted that wireless telephone 32 may be contoured so as to fit and be seated within cordless base 31 where it may have its power supply, e.g. battery recharged in a conventional manner.

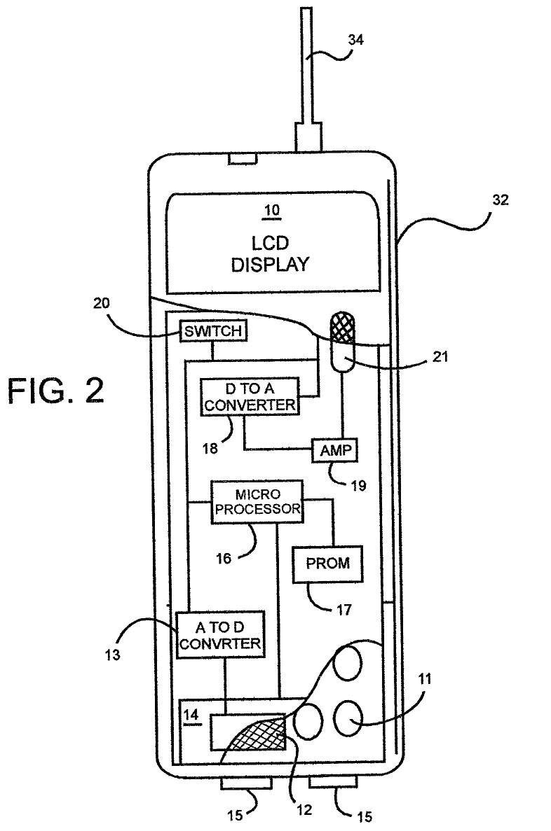

With reference to FIG. 2, an example of an operable wireless telephone member which may be used in the practice of this invention will be described. Wireless telephone member 32 with antenna 34 is connected to D to A converter 18 to convert received RF digital signals, either short range from a cordless base or long range from the cell area station tower into analog signals which are amplified through amplifier 19 and input to speaker 21. Conversely, spoken words into microphone 12 provide an analog signal that is converted into a digital signal in A to D converter 13 and fed to antenna 34 which broadcasts the digital signal either short range to a cordless base or long range to a cell area station tower. The wireless telephone also has an LCD display 10, input keys 11, as well as contacts 15 which connect coinciding contacts on the cordless base for charging of wireless telephone power supply battery 14 whenever the telephone is seated in the cordless base. The telephone member also has a switch 20, which could conveniently be manual, to permit the user to switch back and forth from the short range to the long range wireless communication mode whenever the telephone member is within the short range area of wireless communication. The processing and housekeeping functions within the cellular telephone are controlled by a microprocessor 16 supported by a PROM memory 17.

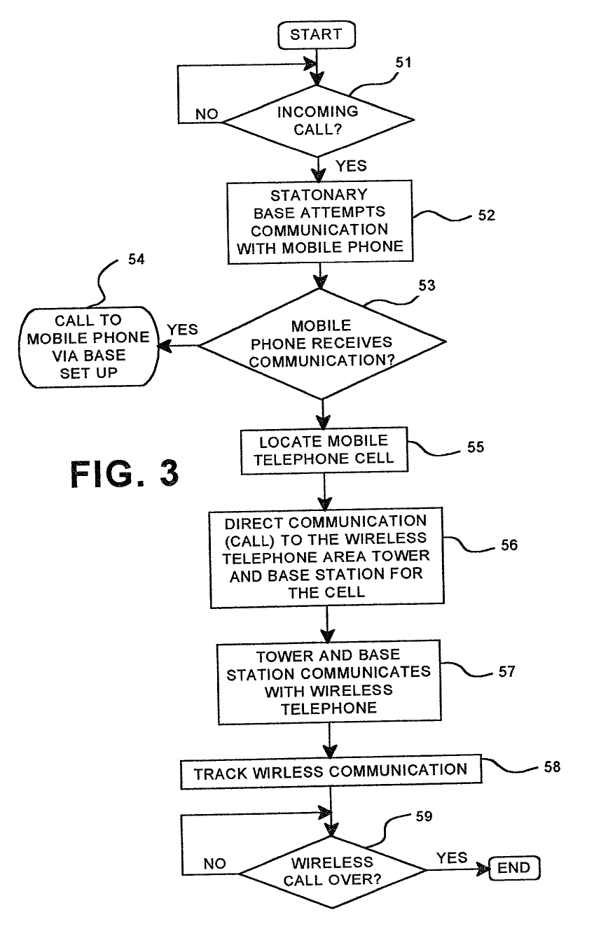

Now with respect to FIG. 3 there will be described how the system handles an incoming telephone call to the wireless telephone. An initial determination is made as to whether there is an incoming call, step 51. If No, the process is returned to step 51 and the call is awaited. If Yes, then communication with the mobile wireless telephone is first tried (short range) as a signal from the cordless base, step 52, and a determination is made, step 53, as to whether the mobile phone has received the communication. If Yes, then the call, short range, is set up through the cordless base to the mobile phone, step 54. If No, the cellular telephone system is requested to locate the cell that the mobile phone is currently in through the use of conventional cellular processes, step 55, and, when located, the call is directed to the cellular tower and base station for the cell within which the mobile phone is in, step 56. The appropriate tower and base station now make the call or communication with the mobile wireless phone, step 57. The cellular system then tracks the call between the tower and the mobile phone, step 58. The end of the call is determined, step 59. If No, the process is returned to step 59 and the end of the call is awaited. If Yes, the call is ended.

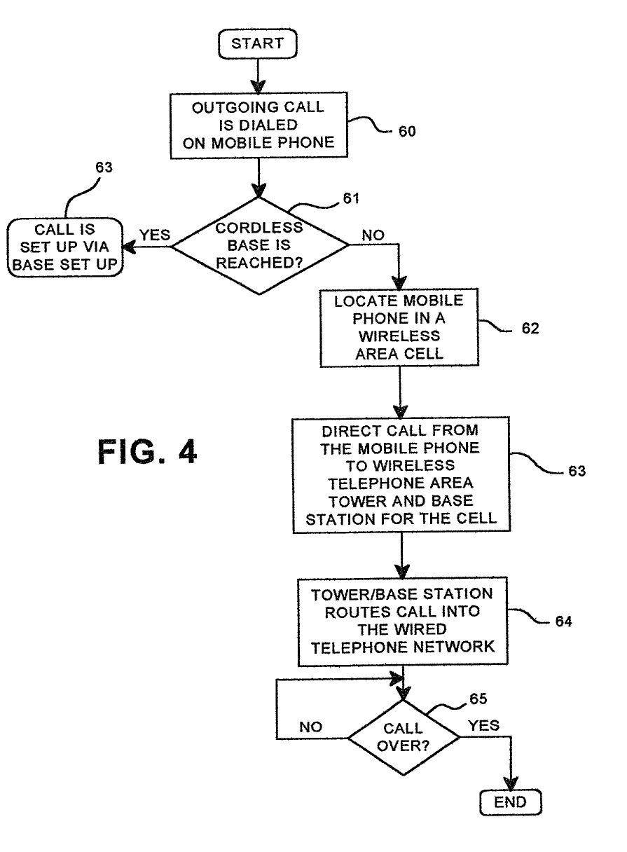

Now, with respect to FIG. 4, an example of an outgoing call from the wireless phone member will be considered. A outgoing call is dialed on the mobile phone, step 60. A determination is made as to whether the mobile phone is close enough to the cordless base that a short range RF signal from the wireless mobile phone has reached the base, step 61. If Yes, then the call, short range, is set up to the cordless base to the mobile phone, step 63. If No, the cellular telephone system is requested to locate the cell that the mobile phone is currently in through the use of conventional cellular processes, step 62, and, when located, the call is directed from the mobile phone to the cellular tower and base station for the cell within which the mobile phone is in, step 63. The appropriate tower and base station now take the call or communication from the mobile wireless phone and connect it through the PSTN, step 64. Then the end of the call is determined, step 65. If No, the process is returned to step 65 and the end of the call is awaited. If Yes, the call is ended.

While the invention has been described using the transmission of voice data, it should be understood that digital data, e.g. data processing and related data, may also be transmitted to and from the wireless phone number, along with voice data or even independently. With respect to cellular transmissions, there is, of course, a well developed commercially available technology for digital communication which could be used in the present wireless telephone when operating in the cellular mode.

Although certain preferred embodiments have been shown and described, it will be understood that many changes and modifications may be made therein without departing from the scope and intent of the appended claims.

1. A wireless telephone system comprising:
a mobile wireless telephone member including:
short range radio frequency communication means for transmitting and receiving voice data over a short range;
long range radio frequency communication means for transmitting and receiving voice data over a long range;
stationary communication means for receiving and transmitting voice data from and to said mobile wireless member voice data over said short range; and
stationary communication means for respectively receiving and transmitting voice data from and to said mobile wireless member voice data over said long range.

2. The wireless telephone system of claim 1 further including means for determining whether said mobile wireless telephone member is outside said short range when said member is receiving or transmitting said voice data.

3. The wireless telephone system of claim 2 further including means for communicating with said mobile wireless telephone member through said stationary short range radio frequency means whenever said member is determined not to be outside of said short range.

4. The wireless telephone system of claim 3 further including means for communicating with said mobile wireless telephone member through said stationary long range radio frequency means whenever said member is determined to be outside of said short range.

5. A wireless telephone system comprising:
a mobile wireless telephone member including:
short range radio frequency communication means for transmitting and receiving voice data over a short range;
long range radio frequency communication means for transmitting and receiving voice data over a long range;
a cordless base member, wired into a wired telephone network, for receiving and transmitting from and to said mobile wireless member voice data over said short range; and
stationary communication means for respectively receiving and transmitting to and from said mobile wireless member voice data over said long range.

6. The wireless telephone system of claim 5 further including means for determining whether said mobile wireless telephone member is outside said short range when said member is receiving or transmitting said voice data.

7. The wireless telephone system of claim 6 further including means for communicating with said mobile wireless telephone member through said cordless base member whenever said member is determined not to be outside of said short range.

8. The wireless telephone system of claim 6 wherein said stationary communication means for respectively receiving and transmitting to and from said mobile wireless member voice data over said long range and includes a wireless telephone area base station wired into said wired telephone network.

9. The wireless telephone system of claim 8 further including means for communicating with said mobile wireless telephone member through said wireless telephone area base station whenever said member is determined to be outside of said short range.

10. The wireless telephone system of claim 9 wherein said means for determining whether said mobile telephone member is outside said short range includes:
means responsive to the initiation of a telephone call for first determining whether a radio frequency communication from said cordless base member can reach said mobile member, and
means responsive to a determination that said communication from said base member cannot reach said mobile member for then automatically switching to radio frequency communication with said mobile member through said wireless telephone area base station.

11. The wireless telephone system of claim 9 wherein said wireless telephone system is a cellular phone system, and said telephone base station area is in an area cell within said cellular system.

12. The wireless telephone system of claim 9 further including means in said mobile wireless member enabling a telephone user to switch between said short range and long range communication means whenever said member is not outside of said short range.

13. The wireless telephone system of claim 12 further including means in said wired telephone network for tracking the respective times of telephone communications through said short range and said long range means.

14. In a wireless telephone system comprising a mobile wireless telephone member short range radio frequency communication means for transmitting and receiving voice data over a short range, and long range radio frequency communication means for transmitting and receiving voice data over a long range; stationary communication means for receiving and transmitting voice data from and to said mobile wireless member voice data over said short range; and stationary communication means for respectively receiving and transmitting voice data from and to said mobile wireless member voice data over said long range, a method for determining whether said communication will be short range or long range comprising:
determining whether said mobile wireless telephone member is outside said short range when said member is receiving or transmitting said voice data, and
communicating with said mobile wireless telephone member through said short range radio frequency communication whenever said member is determined not to be outside of said short range.

15. The method of claim 14 further including the step of communicating with said mobile wireless telephone member through said long range radio frequency communication whenever said member is determined to be outside of said short range.

16. The method of claim 15 wherein said step of determining whether said mobile telephone member is outside said short range includes:
responsive to the initiation of a telephone call, first determining whether a radio frequency communication from said stationary communication means for receiving and transmitting voice data from and to said mobile wireless member voice data over said short range can reach said mobile member, and
responsive to a determination that said communication from said stationary communication means over said short range cannot reach said mobile member, then automatically switching to radio frequency communication with said mobile member through said stationary communication means for said long range communication.

17. The method of claim 16 further including the step of enabling a telephone user to switch between said short range and long range communication whenever said member is not outside of said short range.

18. The method of claim 17 further including the step of tracking the respective times of telephone communications through said short range and said long range, whereby telephone usage may be billed at different rates.

19. A mobile wireless telephone member comprising:
wireless means for communicating with a cordless telephone station within a short distance range; and
means for communicating with a station in a cell of a cellular telephone system over a longer distance outside of said short distance range.

20. The mobile wireless telephone member of claim 19 wherein said cordless telephone station includes a cordless telephone base.

21. The mobile wireless telephone member of claim 20 wherein said cordless telephone station is wired into a wired telephone network.

22. The mobile wireless telephone member of claim 19 wherein said station in a cell of said cellular system is wired into a wired telephone network.
